(19) United States
(12) Patent Application Publication
(10) Pub. No.: US 2012/0154941 A1
(43) Pub. Date: Jun. 21, 2012

(54) COLLECTOR AND CONCENTRATOR OF SOLAR RADIATION

(75) Inventors: Zeev Zalevsky, Rosh HaAyin (IL); Arkady Rudnitsky, Rehovot (IL); Arie Zaban, Shoham (IL)

(73) Assignee: BAR ILAN UNIVERSITY, Ramat Gan (IL)

(21) Appl. No.: 13/392,976

(22) PCT Filed: Aug. 31, 2010
(86) PCT No.: PCT/IL2010/000718

§ 371 Date: Feb. 28, 2012

Related U.S. Application Data
(60) Provisional application No. 61/272,199, filed on Aug. 31, 2009.
(60) Provisional application No. 61/282,268, filed on Jan. 11, 2010.

(51) Int. Cl. G02B 5/10

(52) U.S. Cl. 359/853

(57) ABSTRACT

A system is presented for collecting and concentrating light from a moving light source (e.g. the Sun). The system comprises at least one anamorphic optical element, defining an optical axis and a projection region and having a predetermined effective aperture which defines primary and secondary axes. The effective aperture is configured for collection of optical radiation arriving from a predetermined solid collection angle defining a first range of angles with respect to a plane spanned by said optical and primary axes. The anamorphic optical element is configured such that light passing through said effective aperture within a predetermined first range of angles within said predetermined solid collection angle is concentrated onto at least a part of said projection region. At least one receiver aperture is defined by at least a part of said projection region.

### FIELD OF THE INVENTION

This invention is generally in the field of solar energy collection and concentration and relates to an optical system and method for collection and concentration of solar radiation.

### REFERENCES

The following is a list of references that can be used for better understanding of the background of the invention:
[1] G. K. Skinner, “Diffractive/refractive optics for high energy astronomy”. A&A 375, (2001), 691-700.
[2] N. Davidson, L. Khaykovich, and E. Hasman, “Anamorphic concentration of solar radiation beyond the one-dimensional thermodynamic limit”. Appl. Opt., (2000) 39, 3963-3967.
[3] D. Feuermann, J. M. Gordon, and M. Huleihil, “Solar fiber-optic mini-dish concentrators: first experimental results and field experience”. Solar Energy, (2002) 72(6), 459-472.
[4] US 2006/0191566, by D. T. Schaafsma, Solar concentrator system using photonic engineered materials.
[5] US 2004/0123895, by M. J. Kardauskas and B. P. Piwczyk, Diffractive structures for the redirection and concentration of optical radiation.
[6] U.S. Pat. No. 5,877,874, by G. A. Rosenberg, Device for concentrating optical radiation.
[7] J. Early. “Solar Sail—Fresnel Zone Plate Lens for a Large Space Based Telescope”. in 43rd AIAA/ASME/ASCE/AHS/ASC Structures, Structural Dynamics, and Materials Conference, Apr. 22-25 (2002). (2002). Denver, Colo.
[8] US 2006/0174867, by D. T. Schaafsma, Non-imaging solar collector/concentrator.

### BACKGROUND

Direct optical electromagnetic (EM) radiation conversion to electricity is possible via the photovoltaic effect, which is a quantum conversion effect. The efficiency of this conversion is dictated inter alia by the energy spectrum of the photon flux irradiating a media bulk.

Concentration of solar energy may be useful for reducing costs and increasing efficiency of the radiation conversion. This is due to the fact that the cost of concentration optics is typically much lower than that saved by using smaller coverage area of photo-voltaic cells.

One of the common problems in the solar energy collection systems is associated with the fact that a solid angle of propagation of the most of the solar radiation varies during the day and seasons as a result of the Sun movement. This problem is typically solved by manually tilting the light collection surface of a passive (stationary mounted) collector or that of its associated light defector with respect to the horizon (i.e. using a stationary mounted tilted light collector or its deflector), or by using an active approach according to which the collector or associated light deflector is mounted for angular displacement for tracking the movement of the Sun. Active solar tracking allows for larger total solid angles of radiation collection, but increases the costs of a solar cell system and requires frequent maintenance of moving parts.

Various techniques have been developed aimed at solving the above problems, i.e. increasing the radiation collection and further conversion. In Ref. [1], the author fabricated simple phase Fresnel lens to be installed on aircrafts, which do not involve long focal lengths and yet have high sensitivity and angular resolution. In Ref. [2], the authors discus energy anamorphic concentrator of a big diffuse light source to achieve extremely high concentration in one lateral direction at the expense of that in the other direction, thus preserving the total (two-dimensional) optical brightness. In Ref. [3], the authors have fabricated and characterized solar fiber-optic mini-dish concentrator. Their prototype was 200 mm in diameter and they have transported concentrated sunlight in a one-millimeter-diameter optical fiber. In Ref [4], a non-imaging optical collecting and concentrating apparatus is described for use in solar power applications that is relatively immune from optical incidence angle and therefore does not need to track the movement of the sun to efficiently collect and concentrate optical energy. In Ref [5], a diffractive structure is used for the redirection and concentration of optical radiation. The structure includes a substrate having a diffractive surface and a coating layer disposed over the diffractive surface, while the coating layer having an index of refraction substantially different from that of the substrate. Also, the use of a holographic planar concentrator for collecting and concentrating optical radiation has been proposed (Ref [6]), as well as solar cell based upon Fresnel zone plate lens for large space based telescope (Ref [7]). Ref [8], similarly to Ref. [4], reports on a passive and non-imaging solar collecting and concentrating apparatus for use in passive lighting and solar power applications.

Some other known techniques are aimed at collecting and concentrating solar radiation with high angular uncertainty. For example:

U.S. Pat. No. 6,299,317 presents a method and apparatus for a passive, fiber-optic day-lighting system collects and transports sunlight as a cost-effective technology solution for day-lighting applications. The system utilizes a low concentration ratio sunlight collection system, in expensive optical fibers, and an inexpensive passive solar thermal tracker. The sun-light collection system uses an array of conical compound parabolic concentrators with concentration ratio in the range of 50-500. The sun-light collection system may also use an array of square or rectangular shaped Fresnel lenses with circular concentric grooves. The array of Fresnel lenses can be formed on a single sheet of plastic, which will minimize the cost of manufacturing and reduce the cost of assembly of individual lenses into an array. The sun-light collection may also use arrays of two concentrators in tandem.

US 2007/0246040 presents a non-imaging optical collecting and concentrating apparatus for use in i.e., optical communications, passive lighting, and solar power applications that is relatively immune from optical incidence angle(s) and therefore does not need to track the movement of the sun to efficiently collect and concentrate optical energy is described. The apparatus includes a tubular support structure having a source-facing entrance and an energy-outputting exit. An interior surface of the structure includes a scattering, reflecting and/or diffractive medium to direct incident energy toward an exit of the tubular structure, such that the rays exiting the tube are more collimated and substantially more parallel to the axis of the tube. The collimated beam is then focused or directed by a lens or similar optical element toward a point where the energy may be collected by a detector, optical fiber, or other collection means.

Another approach in optimization of the conversion efficiency involves minimization of the energy losses associated with a mismatch between the photon energies and the active materials in a photo-voltaic cell, e.g. solar cell. The typical energy which can be converted by the active material is determined typically by the optical band gap (minimum optical absorption energy) of the material that absorbs the radiation. The mismatch between the photon energies and the active materials refers to two parts of the radiation energy split by the optical band gap of the cell. Photons with energy higher than the optical band gap of the absorbing material can be absorbed and their energy be converted to electrical energy. These photons participate in the photovoltaic process, but the energy conversion process suffers from the fact that any excess energy, beyond that of the optical band gap, is lost during the photovoltaic process. On the other hand, photons having energy lower than the optical band gap cannot participate in the photovoltaic process. Consequently, from the photovoltaic point of view, this part of the solar spectrum is lost.

A tandem cell is constructed from a series of several photo-voltaic cells where each of these cells is optimized to a part of the spectrum of the EM radiation. The photo-voltaic cells are positioned one on top of the other, in order of decreasing optical band gap. In one option all cells are connected in series with a common current path and a voltage that is the sum of the voltages of all the cells. In this case current matching and the need for rather sophisticated cell fabrication are the main challenges and reasons for the high cost. Consequently these systems are relevant for systems with fairly high concentrations of radiation, e.g. sunlight, for example by sun tracking concentrators which can concentrated the sunlight by a factor of a thousand (>˜1,000×) or more.

Another suggested solution is the use of spectral splitting of the EM radiation. In this method the incident illumination is optically split into several windows of energy ranges. Each of these spectral components/windows is suitable for cells that are optimized to the specific energy range. The spectral components are typically spilt using a prism which spatially separates the incoming radiation into several energy windows and projects the different components on a series of cells optimized respectively. This approach suffers from the difficulty of spectral splitting illumination over the large areas. Therefore, in this method as well, the system typically requires Sun tracking concentrators.

For example, US 2010/200044 presents a solar energy conversion system. The system comprises at least one waveguide arrangement having at least one light input respectively. The waveguide arrangement comprises a core unit for passing input solar radiation therethrough and a cladding material arrangement interfacing with the core therealong. The cladding material arrangement is configured as an array of spaced-apart solar cells arranged along the core unit and having different optical absorption ranges, such that an interface between the waveguide core and the cladding arrangement spectrally splits the photons of the input solar radiation by causing the photons of different wavelengths, while passing through the core unit, to be successively absorbed and thereby converted into electricity by the successive solar cells of said array.

### GENERAL DESCRIPTION

There is a need in the art for a novel light collection system which provides for collecting external radiation (such as solar radiation) from a relatively large range of solid angle of radiation propagation, and also enabling efficient concentration of the collected radiation into one or more defined locations.

As indicated above, active solar tracking allows for larger total solid angles of radiation collection as compared to the conventional passive approach, but increases the costs of a solar cell system and requires frequent maintenance of moving parts. However, efficient collection of sun light using conventional passive approach is a challenging task.

Assuming that light should be collected and coupled into a photovoltaic cell (directly or via concentrator/director) with a small area but large numerical aperture (NA), a simple solution would be the use of a large area lens. This lens will collect light at its surface area and focus the collected light into a single spatial point (point-like spot). The collection efficiency of the lens is thus defined by its entire surface area and a specific direction of light propagation faced by said surface area, e.g. specific position of the sun. The collected light is focused into the focal point of the lens. The concentrated light forms a spot with small area but with large angular range. This solution fits well for a photo-voltaic cell with small area and large NA. The concentration factor in this configuration equals to the ratio between the area of the surface of the lens and the area of the cell that can match the minimal focal spot. However, such systems assume that the light is coming from a given direction with no angular uncertainty. If the light is coming from another direction, the focal point is shifted and the light is no longer coupled into the cell. Therefore, either the cell or the lens has to follow the changing radiation propagation direction (i.e. follow the position of the Sun).

The main idea of the present invention is aimed at providing a novel radiation collection system defining a passive radiation collecting interface that utilizes anamorphic optics which allows projection and concentration of light collected with a relatively large light collection surface (e.g. defining an effective aperture for light collection) onto an elongated projection region, and allows receiver aperture(s) to extend along said projection region for collecting the concentrated light. The anamorphic optics may include a cylindrical lens (e.g. tapered) or a prism (e.g. tapered prism) that can have a desirably large light collection surface thus enabling coupling/collecting direct (directional) and also diffused light and projection of the same onto the line-like or planar elongated projection region. Also, the invention provides for coupling planar waveguide(s) to the elongated projection region for transporting the radiation to the photo-voltaic (PV) cell(s).

It should be noted that the invention utilizes the principles of anamorphic optics, namely optics that has different optical functions/powers in the horizontal and vertical dimensions of an object being projected/imaged. The anamorphic optical element thus defines a first primary axis which extends in a plane perpendicular to the optical axis of the element and is parallel to the longitudinal axis of the projection region/focal region. A specially designed cylindrical lens, as well as a prismatic structure, of the invention is an example of such anamorphic optical element. Therefore, although the description below refers at times to “cylindrical lens” and “tapered cylindrical lens”, these terms should be interpreted broadly.

It should also be noted that the term anamorphic optical element as used herein relates to an optical element configured to perform certain manipulation/optical function on light along one axis (primary axis), while performing a different manipulation on the light along the other axis (secondary axis). The primary and secondary axes are intersecting axes substantially perpendicular to the optical axis of the anamorphic optical element. An anamorphic optical element can be, for example, a lens with different optical powers along the two different axes, a cylindrical lens having optical power only on a single axis, a prismatic structure, or other forms of optical elements configured with different optical functions along the different axes perpendicular to its optical axis.

The invention is based on the understanding that during a day the Sun is moving along a curved one-dimensional trajectory across the sky with day-night angular range/extent of about 180 degrees about a certain direction/axis (north-south). Practically, only about 100 degrees angular segment from the 180 degrees range is useful for collection of Sun's energy. During the change of seasons, the angular position of this trajectory changes within a total angular range of about 45 degrees about a second direction (east-west). The invention uses this a-priori information in order to design passive light collection optics to perform efficient collection of solar radiation without tracking the Sun's movement in the sky.

Despite the movement of the Sun along these well defined trajectories, the optics of the present invention is capable of collecting and concentrating light/solar energy and directing the light to the same spatial location where a receiver aperture can be position. For example, the receiver aperture may be associated with a light collection surface of a photo-voltaic (PV) conversion element (cell) or with an input facet of one or more waveguides configured for guiding the collected light onto a photo-voltaic (PV) cell.

According to some embodiments of the invention, the waveguide itself can also be used to perform a part of the light concentration operation. This is because waveguides can be configured to concentrate a light beam by converting its cross-sectional area (i.e. to reduce the area) into a wide solid angle (i.e. to output concentrated light with increased solid angle).

The invention can be used with photo-voltaic cells and is therefore described below with reference to this specific application. It should however be understood that the principles of light collection of the invention are not limited to this specific application. The collected radiation can for example be used for other purposes, such as illumination of interior rooms, and many other applications.

Thus, the present invention utilizes prior knowledge of the solid angle defined by the Sun's movement in the sky for providing a passive, highly efficient, system for collecting and concentrating electromagnetic radiation. The collected radiation may be coupled into one or more waveguides for transporting the radiation to one or more PV cells or other locations/receivers or may be directly coupled thereto. By utilizing this a-priori knowledge about the trajectory of the Sun, the passive light collection system of the present invention optimizes the light concentration value by reaching a high factor of concentration and allows approaching the theoretical bound defined by the law of brightness.

It should be noted that according to the invention flexible planar waveguides can be used for guiding the collected light towards a light conversion system (PV cell). Advantageously such planar waveguide(s) can be folded such that its/their output facet matches the dimension of PV cell(s) to which the light is directed. This manipulation of waveguides dimensions can be used to provide high conversion of brightness from area to a solid angle and provide even more efficient conversion of solar radiation to electricity.

The present invention may also be implemented by utilizing existing optical fibers which are used for data communication purposes, in the field of optical communication network. Such optical fibers are widely used for large distance communication and may be used by the system of the present invention for transferring collected energy from a distant collection location (e.g. outside of a city) to photo-voltaic cells arrangement located at a more accessible location (e.g. located within the city).

The technique of the present invention thus utilizes the principles of anamorphic optics and a specific design thereof, which can be accommodated to collect light from multiple directions by a large collection surface and is capable of bringing/concentrating the collected light to a single spatial location. The anamorphic optics used in the invention may be formed with optical diffractive elements (e.g. appropriately patterned light collection surface) for spectral splitting purposes and/or be associated with one or more waveguides as receiver(s) of the collected radiation at the focal elongated region defined by the optics and/or as light guide(s) for guiding the collected radiation to said focal elongated region. For example, the light collection surface of the cylindrical lens/prism and/or the surface of the waveguide(s) may be patterned (spatially engraved, e.g. formed with a grating) to generate spectral splitting of the energy being collected or of the collected energy.

Thus, according to one broad aspect of the present invention, there is provided a system for collecting and concentrating light from a moving light source. The system includes at least one anamorphic optical element, defining an optical axis and a projection region, and having a predetermined effective aperture which defines primary and secondary axes. The effective aperture is configured for collection of optical radiation arriving from a predetermined solid collection angle which defines a first range of angles with respect to a plane spanned by said optical axis and said primary axis. At least a part of said projection region defines at least one receiver aperture. The anamorphic optical element is configured such that light passing through the effective aperture within a predetermined first range of angles is concentrated by a first optical function of said element onto at least part of said projection region. For example, the first range of angle may be a range of about 12 degrees and may extend up to about 45 degrees.

Said anamorphic optical element is configured for collecting and projecting, onto substantially overlapping parts of said elongated region, optical radiation arriving from different angles within a second predetermined range of angles with respect to a plane spanned by the optical axis and the secondary axis. The second range of angles may be of about 110 degrees and may also extend up to about 150 degrees.

The light collection and concentration system can be configured as a passive optical system for collecting and concentrating light from a moving light source. The system is configured for collection of optical radiation arriving from a predetermined solid angle. Light arriving from said solid angle and passing through the effective aperture of the anamorphic optical element is concentrated onto an elongated projection region which may extend parallel to the primary axis of the anamorphic optical element. By arranging the system such that the primary axis is substantially perpendicular to the main direction of movement of the radiation source, the system collects light emitted by said source during most of the propagation of the source.

The first range of collection angles is typically selected in accordance with a known trajectory of radiation source movement during a certain period of time (e.g. to cover seasonal changes in the Sun's position). The second range of collection angles may be selected in accordance with a known trajectory of the radiation source (Sun) during a certain period of time (day-night trajectory). Considering the Sun as the radiation source, the trajectory is defined by the movement of the Sun in the sky during a day, the first axis is substantially parallel to the direction of the propagation of the Sun during a day and the second axis is parallel to the direction of the changes of the trajectory between the different seasons of a year.

Accordingly, the system of the present invention is capable of passive collecting optical radiation from a range of collection angles thus allowing collection of both direct and scattered/diffused optical radiation with increased light collection efficiency. The wide angular range of passive collection is more tolerant to weather conditions since it collects diffusive light in contrast to active systems.

The design of the passive light collecting optics of the present invention takes into account the angularly limited movement of the Sun (i.e. radiation source), and unlike active trackers, the optical system of the present invention collects also the diffused light. In northern countries, where most of the sunlight is diffused, and also in sunny countries, during cloudy days, collection of diffused light to the solar cells will yield production of electricity at high conversion efficiency which is less dependent on the weather conditions.

According to some embodiments of the invention, the system for light collection and concentration may comprise a spectral splitting assembly. The spectral splitting assembly allows directing different spectral ranges of light onto different photo-voltaic cells optimized for the specific spectral ranges. The spectral splitting assembly may be placed on the effective aperture of said anamorphic optical element. Alternatively or additionally, spectral splitting assembly may also be configured as a spectral splitter extending along a surface of one or more of the waveguides to thereby separate light portions of different spectral ranges and allow their output from the waveguide at respectively spaced-apart locations along the waveguide.

The receiver aperture, which extends along at least a part of the projection region, may be associated with one or more light receiving elements. For example, such elements may include one or more waveguides and/or photo-voltaic cell(s) and/or an entry of volume to be illuminated by the collected light. For example, one or more waveguides may be used for guiding the radiation coupled thereto towards one or more different dedicated directions.

In case of more than one receiving elements (e.g. waveguides), the receiver aperture may be a common aperture of all the waveguides. The waveguides may in turn be configured for coupling thereto at least a portion of the collected radiation such that different segments of the first range of angles are coupled into different waveguides. For example, two or more waveguides may be configured and arranged for coupling collected radiation from different segments of said predetermined collection angle, corresponding to main directions of propagation of collected radiation from different trajectories of the radiation source (the different trajectories of the radiation source may be the trajectories of the Sun during different seasons respectively); and/or such two or more waveguide are configured for receiving and guiding different spectral components of the collected radiation. As indicated above, the receiver aperture may be the input aperture of a photovoltaic cell or of other optical instruments or illuminated volume. Also, one or more planar waveguides may be coupled to an elongated projection region for providing efficient optical coupling thereto. The use of flexible waveguides may simplify the orientation of the system of the present invention.

The waveguides can be coupled to the anamorphic optical element at different coupling orientations, the system can collect radiation also when the plane of the source' trajectory of movement changes, e.g. becomes shifted along the “summer-winter” axis. In this case, the collected radiation is coupled to different waveguides. The use of waveguides provides a good tool for transporting collected and concentrated light. Also, an array of specially tapered cylindrical cones can be used to efficiently couple the collected light onto the planar (flexible and/or plastic) waveguides and thus provide the radiation collection system of the invention to be efficient and easy to configure. The waveguides may be combined together to guide the collected radiation into photo-voltaic cells of any possible configuration and position in respect to the collection array.

The one or more waveguides coupled to the receiver aperture may direct the collected light to the same or different locations. Multiple waveguides can guide the radiation coupled thereto towards different locations or towards the same location.

The use of appropriately designed anamorphic optical element allows for collecting radiation regardless to the movement of the radiation source along its trajectory in a way that collected radiation is always concentrated/projected onto a predetermined region (e.g. focal region).

According to some embodiments of the present invention, the anamorphic optical element comprises a cylindrical lens curved at least about said primary axis. The lens concentrates the radiation collected via its external surface onto an elongated focal region parallel to the first axis of the optical element and parallel to the main direction of movement of the radiation source. The cylindrical lens is arranged such that movement of the radiation source along its trajectory results in a corresponding shift of the focal spot along said focal region. In some embodiments, the effective aperture of the cylindrical lens has an elongated shape aligned along the primary axis of the lens. According to some other embodiments of the present invention, the anamorphic optical element is formed as a sealing element of one or more photo-voltaic cells. The anamorphic element has a focal region located downstream of light propagation through the anamorphic element. Such anamorphic element, providing sealing for photo-voltaic cell, may be a cylindrically shaped optical element arranged around a cylindrical photo-voltaic cell. The cylindrically shaped optical element is configured as a cylindrical lens and has a substantially circular light collection surface. In this regards, the receiving element may be located at the center of the cylindrical lens and the system, i.e. sealing optics in the form of cylindrical lens and cylindrical receiving element, is arranged such that light coming from all directions is sufficiently concentrated onto the receiving element.

According to some other embodiments of the present invention, the anamorphic optical element comprises a prismatic structure. The prismatic structure has a facet defining said effective aperture for collection of solar radiation with the predetermined collection angle, and has a top region comprising said projection region. The side walls of the prismatic structure are constructed as waveguides for guiding collected light by total internal reflection from said effective aperture towards the top region of the prismatic structure. The top region of the prismatic structure has a geometry corresponding to said projection region onto which the collected radiation is concentrated.

Generally speaking, the cylindrical lens or prismatic structure has a tapered or cone-like configuration in order to have as large as possible light collection surface. The invention may use an array of specially tapered cylindrical cones which efficiently couple collected light into planar and possibly flexible (e.g. plastic) waveguides or directly illuminate a PV cell or another target. Due to the use of so-designed anamorphic optical element(s), the movement of the light source along its trajectory does not reduce the coupling of the collected light into the planar waveguide. Due to the tapered design of the optical element, light being collected is appropriately converged into a one-dimensional region. An input facet of the waveguide (e.g. planar, flexible) is located along said one-dimensional region allowing coupling of the light coming from different locations of the source. The waveguides used are preferably flexible in order to provide desired freedom in the positioning of its output facet. Combining several planar waveguides as such, and bringing them to the same photo-voltaic cell allows collection of radiation coming from different locations by the same photo-voltaic cell, e.g. different trajectories of the Sun in different seasons along a year.

According to another broad aspect of the invention there is provided a solar radiation system comprising the optical light collection and concentration system described above, and at least one photo-voltaic cell having a light receiving surface extending along at least a part of said receiver aperture.

According to yet another broad aspect of the invention, there is provided a solar radiation system comprising the optical light collection and concentration system described above, and one or more waveguides having one or more input facets respectively extending along one or more parts of said receiver aperture.

According to yet further broad aspect of the present invention, there is provided a method for collecting solar radiation onto one or more photo-voltaic cells, the method comprising:

(a) providing a solid angle of solar radiation propagation in accordance with a first direction corresponding to the trajectory of the Sun during the day and a second direction in which said trajectory varies between seasons, and determining, based on said first and second directions, first and second angular ranges corresponding to the direction of the Sun light propagation during the day and in different seasons.

(b) configuring an anamorphic optical element having an effective light collection aperture with first and second different optical functions associated with primary and secondary axes of the anamorphic optical element, such that said first optical function is operable to collect and concentrate light arriving from different directions within said first angular range and to direct the concentrated light onto substantially the same light projection region, and said second optical function is operable for collecting and concentrating light arriving from different directions with respect to said second angular range ant to project the concentrated light onto substantially overlapping regions at said projection region; and

(c) coupling one or more receiving apertures to said projection region for collecting therefrom concentrated light arriving from any direction within said solid angle.

The invention also provides a method for collecting solar radiation onto one or more photo-voltaic cells, comprising:

(a) providing a solid angle of solar radiation propagation in accordance with a first direction corresponding to the trajectory of the Sun during the day and a second direction in which said trajectory varies between seasons;

(b) providing a system for collecting and concentrating light from a moving light source as described above; and

(c) mounting said system such that its primary and secondary axes are substantially parallel to said first and second directions respectively to thereby optimize a solid angle from which Sun light is collected by said system.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 illustrates a light collection and concentration system according to an embodiment of the present invention;

FIG. 2 illustrates a light collection system including a cylindrical lens according to an embodiment of the present invention;

FIGS. 3A and 3B show simulation of propagation of light rays being collected by the system of the invention constructed generally similar to that of FIG. 1, where FIG. 3A shows numerical simulation for collection of light corresponding to one-dimensional movement of the light source (the collected light ray is propagating along the optical axis of the system) and FIG. 3B shows numerical simulation for collection of light corresponding to for full one-dimensional movement of the light source as well as a 6 degrees angle from the optical axis;

FIG. 4 is an illustration of a light collection and concentration system configured according to another embodiment of the present invention, associated with several waveguides at the receiver aperture of the system, each waveguide being responsible for collecting the Sun light from a different angular sector of 4 degrees along the “summer-winter” axis of the Sun's movement;

FIG. 5 shows simulation results of spectral splitting using a grating placed along a waveguide;

FIGS. 6A-6B illustrate yet another embodiment of the present invention, where FIG. 6A shows a light collection and concentration system utilizing a prismatic structure; and FIG. 6B shows simulation of light collection and concentration by the system of FIG. 6A;

FIG. 7A-7J illustrate different configurations of the embodiment shown in FIGS. 6A-6A, FIG. 7A show a one-stage configuration of the prismatic structure, FIGS. 7B-7C show simulation results of this configuration, FIG. 7D-7E show a two-stage configuration and simulation results of the two-stage configuration, FIGS. 7F-7G show two different three-stage configurations of the prismatic structure collector, and FIG. 7H-7J show simulation results of the three-stage configuration of FIG. 7G;

FIG. 8 illustrates a light collection and concentration system according to yet further embodiment of the invention capable of collecting Sun light coming from various angles and illuminating a cylindrical like optics;

FIGS. 9A-9B are pictures of light collectors configured according to an embodiment of the present invention;

FIGS. 10A-10F show experimental set up and experimental results obtained with this set up using green laser light collection from different locations of the laser that demonstrate the invariance to the direction of the laser in the process of the energy collection;

FIGS. 11A-11D show similar experimental results using collection of white light from different while light source locations;

FIGS. 12A-12D show experimental set up for passive Sun light collection for 2-D movement of the Sun (FIG. 12A) and experimental results obtained with this set up for green light collection (FIGS. 12B-12C) and white light collection (FIG. 12D) from different source locations along a two-dimensional path/trajectory;

FIGS. 13A-13B show experimental results for the technique of the present invention for the light collection from different angles of light propagation during the Sun movement along the day-night axis/trajectory (FIG. 13A) and along summer-winter axis; and,

FIG. 14 is a graph showing the efficiency of the system of the present invention.

### DETAILED DESCRIPTION OF EMBODIMENTS

The present invention provides for passive collection of light from a movable/moving light source (e.g. the Sun), namely collection of light propagating from the light source by the same optics (i.e. stationary mounted optics having a given collection angle) to the same concentration region (point), where a receiver aperture (e.g. a photo-voltaic unit/cell) is located. The receiver aperture may be an input port/aperture of one or more receiving elements (waveguides or photo-voltaic cells), or an input optical window of one or more volume/cavities to be illuminated by the collected light.

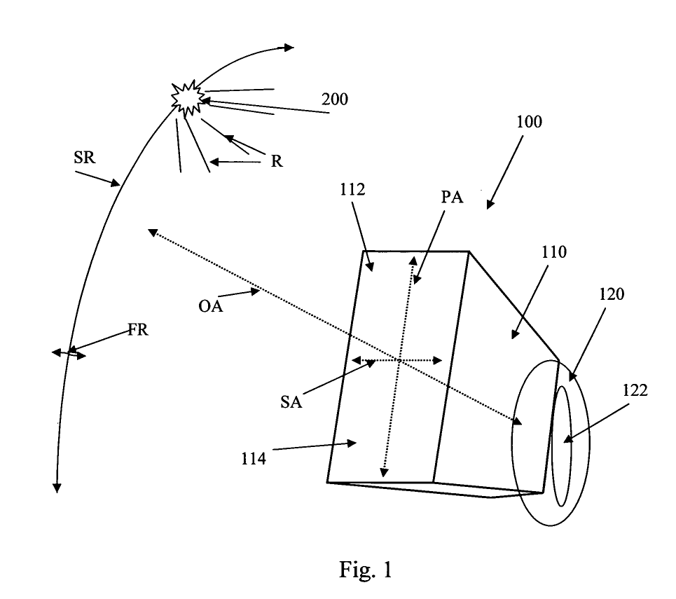

Reference is made to FIG. 1 illustrating schematically a system 100 according to the present invention configured for collecting and concentrating light from a moving light source 200. The system includes at least one anamorphic optical element 110, defining an optical axis OA and a projection region 120, and having a predetermined effective aperture 112 which defines primary PA and secondary axes SA. In the present non-limiting example, the effective aperture is illustrated on the light collection surface 114 of the anamorphic optical element 110. The system also includes at least one receiver aperture 122 defined by at least a part of said projection region 120.

The effective aperture 112 (light collection surface 114) is configured for collection of optical radiation R arriving from a predetermined solid collection angle defining a first range of angles FR with respect to a plane spanned by said optical and primary axes OA and PA respectively. For example, the first range of angles FR from which the system is configured for passively collecting light may be selected in accordance with the movement of the light source 200 with respect to/about the primary axis PA.

The anamorphic optical element 110 is configured such that light passing through said effective aperture 112 within the predetermined first range of angles FA is concentrated onto at least a part of the projection region 120. Optionally, the projection region 120 is an elongated region substantially parallel to the primary axis PA. Accordingly, the anamorphic optical element 110 may be configured for collecting and projecting optical radiation arriving from different angles within a second predetermined range of angles SR (e.g. corresponding to the movement of the light source 200 about the secondary axis SA) onto substantially overlapping parts of said elongated projection region 120.

The system 100 of the invention may also be associated with a plurality of waveguides (not shown) arranged at the receiver aperture 122 of the projection region 120. The waveguides may be arranged such that each waveguide is collecting energy form a different propagation direction corresponding to different seasonal period. As the Sun moves along the summer winter trajectory (FR), light propagating within different angular segments during the Sun's movement is concentrated onto projection region 120 and successively collected by at least one of the waveguides. This can be effectively used by providing different waveguides at the receiver aperture for receiving and guiding light components associated with different angular segments of collection depending on the time of year. Since the cost of optical waveguides is very low relative to the cost of a photo-voltaic cell or a lens, the use of multiple waveguides in the system is cost effective as it obviates replicating the optics itself and/or the photo-voltaic cells.

Moreover the invention also provides for efficient passive light collection during the day-night motion of the Sun. The Sun generally moves along a day-night trajectory (SR) with angular extent of about 180 degrees. Efficient collection of the light radiation from the Sun, while it is in different angular poisons with respect to system 100, is achieved according to some embodiments by utilizing one or more planar waveguides (not shown) optically coupled with the elongated projection region 120 of the anamorphic optical element. As the elongated projection region 120 is substantially parallel to the day-night trajectory (SR), optical radiation arriving from different angles during different time intervals of the day (as the Sun is located at different positions along this trajectory) is concentrated and projected onto substantially the same projection region. Namely, during the day-night motion of the Sun the radiation is projected onto substantially overlapping parts of the elongated region. The radiation/light is therefore efficiently collected by one or more planar waveguides coupled thereto.

The solution provided by the present invention realizing an efficient passive collection of light relates to the optical basic law of brightness. The law of brightness conservation is formulated as:

n²ΔA·ΔΩ=const (1)

where n is the refractive index of the collecting optics, ΔA is the collection area and ΔΩ is the solid angle (defined by the first and second angular ranges FR and SR) from which the radiation collection is performed. Thus, since the photo-voltaic cell can collect light from a solid angle ΔΩ of 2π Steradians (hemi sphere) while the radiation coming from a distant source (e.g. the Sun) is a-priori limited to a much smaller solid angle (of about π²/8), the area of collection can be reduced accordingly, and in this way a high concentration factor can be obtained.

Following the low of brightness, the maximal concentration of passive collection of solar radiation can be:

$$η = \frac{{n}^{2} 4 π}{Δ ϕ [ cos ( \frac{π}{2} - \frac{Δ θ}{2} ) - cos ( \frac{π}{2} + \frac{Δ θ}{2} ) ]} = \frac{{n}^{2} 4 π}{2 Δϕsin ( \frac{Δ θ}{2} )} \qquad ( 2 )$$

where Δφ and Δθ present the angular movement of the Sun in each direction. The exact angles presenting the Sun trajectory differ according to the location relative to the equator, for example, the Sun covers an angle of Δφ=150° (5π/6) along the day and perpendicular shift of about Δθ=45° (π/4) between the summer and winter trajectories. Assuming n=2 (relevant for glass), a concentration factor of about 25 may be obtained (e.g. 25 Suns).

The technique of the present invention is based on the use of the principles of anamorphic optics (which may include a refractive element, and possibly also reflective guiding element and/or optical diffractive element) configured to collect radiation from different directions and concentrate the radiation onto a single spatial location. The radiation is generated by a radiation source moving within a known and limited spatial region along known trajectories. The radiation collection system 100 of the present invention is therefore arranged to collect radiation coming from within the solid angle defined by the Sun's movement during the day and during the seasons and concentrate the collected radiation onto the same location, being the projection region 120, irrespective of the sun's position. At the projection region 120, a photo-voltaic cell or waveguide associated with the same can be placed for collecting the solar radiation. The technique of the present invention also provides for realization of an array of such anamorphic optical elements (specially tapered cylindrical cones or cylindrical lens(es)) which couple collected light into planar (and possibly also flexible and/or plastic) waveguides.

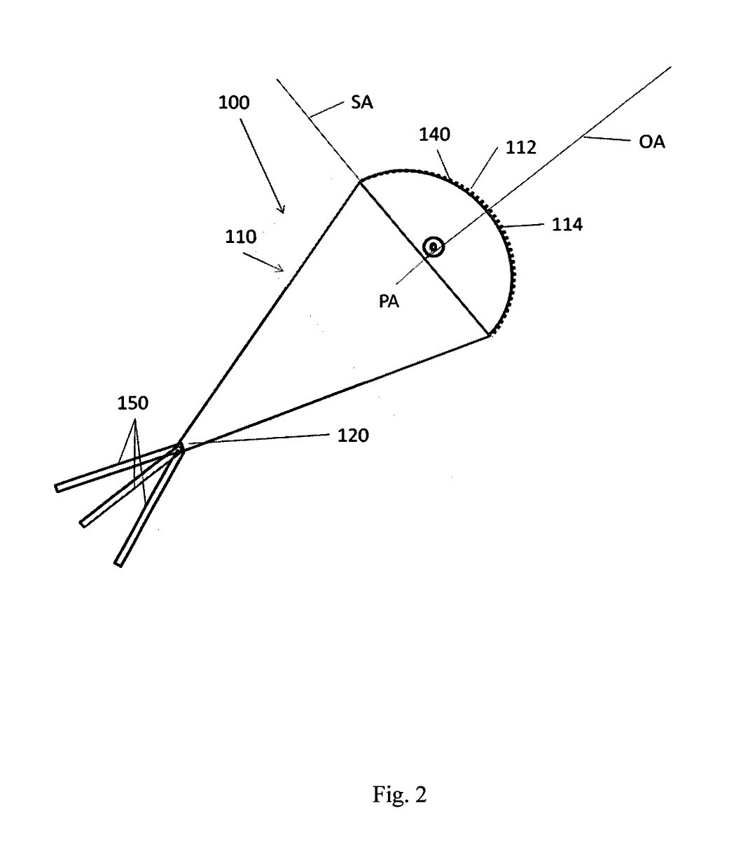

Reference is made to FIG. 2 illustrating an optical system 100 of the present invention for collecting electromagnetic radiation and projecting it to a concentration region. The system 100 includes one or more anamorphic optical elements defining primary and secondary axes associated with different optical function (optical powers of the cylindrical lens). One such element 110 in the form of a tapered cylindrical optics/lens is exemplified in the figure. The lens 110 has a light collection surface 114, by which it is exposed to the electromagnetic radiation and which defines the effective aperture 112 of the system. The lens 110 is configured for projecting (e.g. focusing) collected light onto a projection region (preferably planar elongated projection region) 120.

Such cylindrical tapered lens 110 enables to concentrate light collected with a large solid angle of collection to the elongated planar region 120 which extends along an axis parallel to the primary axis PA of the cylindrical lens 110. The projection region 120 serves as a receiver aperture, namely an input aperture of one or more receiving elements (planar waveguides or photo-voltaic cells), or an input optical window of one or more volume/cavities to be illuminated.

As shown in the present example, the system 100 is associated with three waveguides, generally at 150, having a common receiver aperture at the projection region 120. Projection region 120 is positioned with respect to (e.g. at a facet of) the cylindrical tapered lens 110 such that light incident on the light collection surface 114 from a desired first range of angles (e.g. a range of 45 degrees) is concentrated and projected onto the projection region 120. In the present example, each of the three waveguides is optically coupled to the receiver aperture and is configured to collect light from a different part of the first angular range (e.g. each waveguide is collecting light from an angular range of 15 degrees).

Thus, the taper (lens) 110 is exposed to external radiation by its light collection surface 114 and couples the collected radiation into one or more waveguides 150 which may be flexible and/or planar waveguides. The waveguides 150 transport the collected and concentrated light to one or more locations, where for example light converters (such as a photo-voltaic cell) are placed. Alternatively or additionally, the waveguides transport the collected light to an object/region to be illuminated. Thus, the waveguides 150 having the common receiver aperture are arranged for guiding light components passing therethrough along different paths to spatially separated receiving locations.

The system 100 may include a spectral splitter 140. In some embodiments of the invention, the spectral splitter is located upstream of or integral with the light collection surface 114 so as to be in the vicinity of the effective aperture of the system 112. As exemplified in the figure, this can be implemented by using a diffraction grating 142 placed on top of the light collection surface 114 of the lens 110 in order to spatially separate different spectral components of the solar radiation. This allows utilizing multiple waveguides 150 optically coupled to the projection region 120 to receive different spectral components and guide them to different locations in which wavelength specific PV cells may be accommodated for providing higher conversion efficiency.

The cylindrical optics 110 may be configured such that the primary axis is arranged along the main axis (trajectory) of movement of the light source. This provides that the movement of the light source does not change the position (120) of the light projection region of said optics in space, and therefore does not reduce the coupling of light into waveguide(s) which may be located at the projection region 120 of the system 100. One or more (flexible) waveguides are arranged such that the input facet of the waveguide is located at the projection region 120 to which the light is concentrated and the waveguides can thus transport the received light to remote locations.

The use of plurality of flexible waveguides 150 in the present invention might also be advantageous enabling the system to be modular. By proper arranging the waveguides, almost any configuration of collecting optics and photo-voltaic cells' array (i.e. physical dimensions thereof) can be matched or adjusted. In addition, the system is tolerant to the distance or to the location of the optics with respect to remote photo-voltaic cells array (e.g. the optics can be located on the building's roof while the associated photo-voltaic cells with their electronics may be in the basement).

The use of waveguides 150 allows efficient conservation of the law of brightness (conversion between area and angular span). Optionally, according to some embodiments of the present invention, the waveguides are narrowed at their distal edge by which they are connected to the photo-voltaic cell. This provides that the overall area of the receiver aperture (e.g. by which the waveguides are connected to the anamorphic optical element) is reduced while its numerical aperture is increased to almost 180 degrees (which is the angular span at which the optics can collect radiation). This provides for utilizing the optical waveguides to perform the desired conversion between area and angular span or vice versa.

It should be noted that the waveguides are not necessarily narrowed at their distal edge. In case the waveguides are not narrowed, they can still be arranged in space such that the overall angular span of all the waveguides having a common receiver aperture will reach 180 degrees. In this case, the waveguides configuration may be such that the surface area of the photo-voltaic cell collecting the energy from all the waveguides is smaller than their overall area. For example, this can be achieved when the waveguides illuminating the photo-voltaic cell extend along circumference of a sphere and all of them are directed by their distal ends towards the center of the sphere where the PV cell is located.

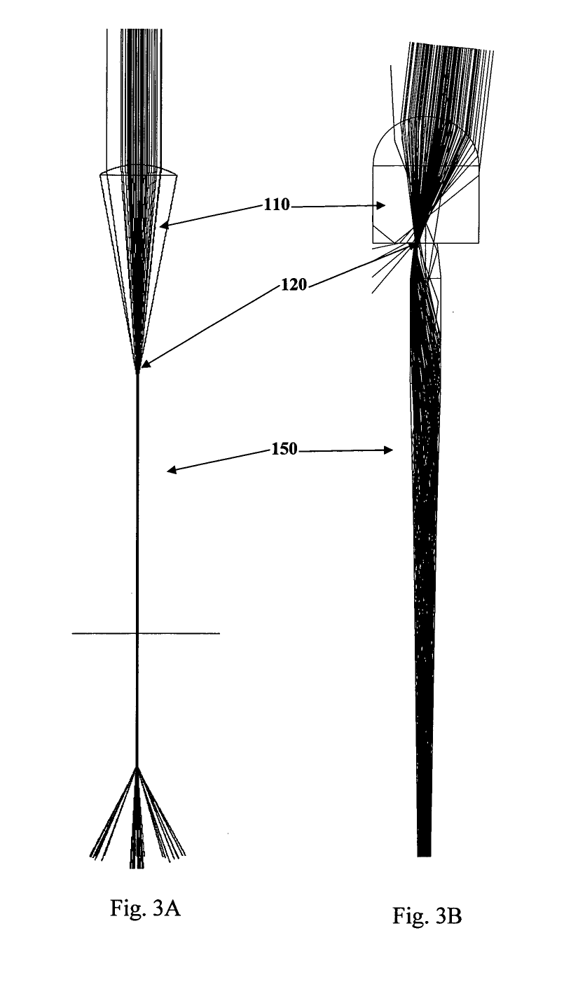

Reference is now made to FIGS. 3A and 3B showing simulation of light collection by the system according to the present invention, i.e. the cylindrical lens 110 configured generally similar to that of FIG. 2, and being associated with a single waveguide 150. The collected radiation is being continuously optically coupled into the single waveguide 150 at the projection region 120 during the light source (e.g. the Sun) movement along the entire trajectory. FIG. 3A shows a simulation of collection of the Sun light propagating parallel to the optical axis of the anamorphic element 110 (cylindrical lens). FIG. 3B corresponds to the light collection scheme for the Sun position at 6 degrees along the summer-winter axis (i.e. 6 degrees from the plane spanned by the optical and primary axes (OA and PA in FIG. 1 respectively) of the lens 110. The Sun's position is shifted by 6 degrees from the optical axis of the lens; this shift in the location of the Sun represents part of the Sun movement along the seasons of the year. As shown in the FIGS. 3A and 3B, the single waveguide input facet collects light coming from angles of up to 180 degrees along the day-night axis (primary axis) and up to 12 degrees along the summer-winter axis (secondary axis).

For example, four waveguides can be coupled to the same tapered cylindrical lens 110 at its receiver aperture and guide the collected light to the same photo-voltaic cell. Each one of these four waveguides would collect light in different segment of the 12 degrees angle out of the 45 degrees angular segment of the movement of the Sun along the summer-winter axis. Thus, when the position of the Sun is varied due to seasonal changes, each time a different waveguide 150 is mainly involved in carrying the collected and concentrated radiation from the same tapered lens 110 to the same photo-voltaic cell.

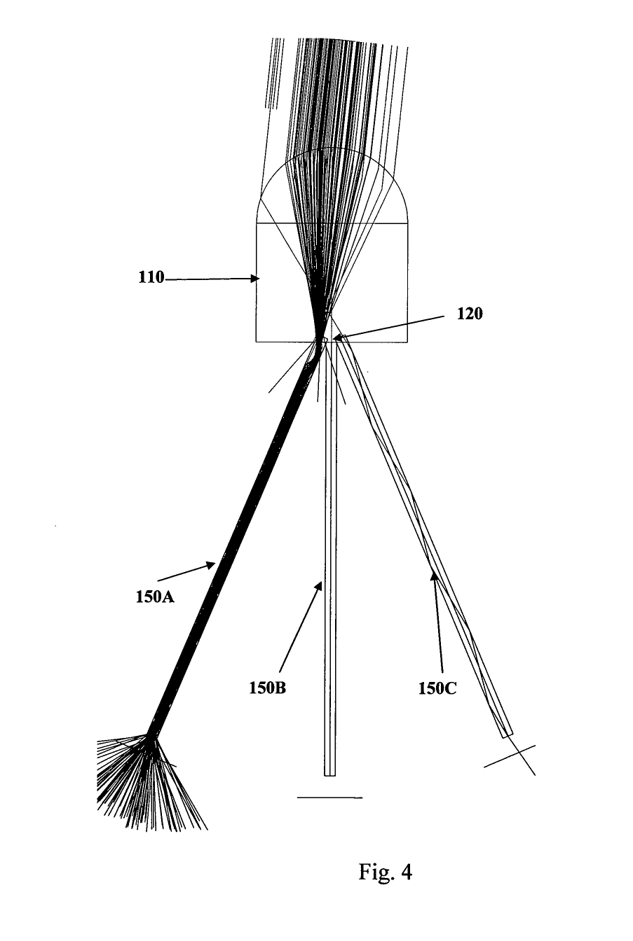

FIG. 4 simulates coupling of the collected and concentrated light to three waveguides, enabling selective coupling of light to one of these waveguides depending on the location of the light source. The light is coupled into different waveguides from different angular positions of the Sun between the seasons of the year. One waveguide 150A collects light during the summer, another waveguide 150B collects light during the autumn and the spring, and the third waveguide 150C collects light during the winter. Any different configuration or different number of waveguides is possible depending on the latitude where the system is located.

As indicated above, the invention preferably also utilizes spectral splitting of the collected radiation. Turning back to FIG. 2, this can be implemented by adding a diffractive optical grating like element 140 on top of the external surface 114 of the cylindrical lens 110. The diffractive element 140 is configured such that each of at least three possible spectral bands (e.g. red, green and blue) is coupled into a different one or more waveguides 150. For example, 12 waveguides can be provided and arranged such that each set of four waveguides receives a different spectral band of the collected and concentrated radiation, independently on the position of the radiation source (the Sun). Within each set, a different one or more waveguides receive the concentrated radiation depending on the position of the radiation source. Accordingly, concentrated radiation of different wavelength ranges may be guided to different locations, e.g. towards different photovoltaic cells which are respectively designed for the corresponding specific spectral bands. Thus, in this case, the system might include at least three photo-voltaic cells associated with the common tapered cylindrical lens, each photo-voltaic cell being optimized for a different spectral band.

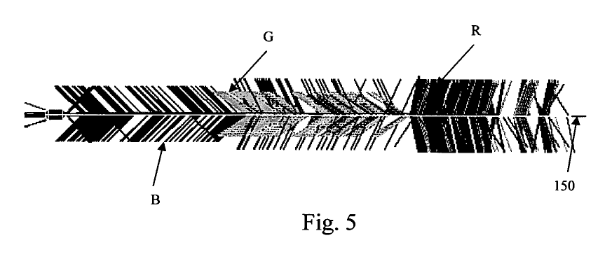

According to some embodiments of the invention, spectral splitting is implemented based on a diffractive structure extending along the waveguide (e.g. along its cladding). FIG. 5 shows simulation of spectral splitting of light to different spectral components during the light propagation in the waveguide. A diffractive grating may be placed along the waveguide 150 in order to impair/break the total internal reflection of light at different location along the waveguide for different wavelength range. Thus, light components of different spectral ranges escape from the waveguide at different locations therealong.

It can be seen from the figure that although some mixing of spectral bands still exists, a significant spatial separation between the releasing of red R, green G and blue B wavelengths is obtained. When light, while propagating through the waveguide via the effect of total internal reflection, interacts with the diffractive structure, the condition of total internal reflection becomes destroyed for some wavelengths while being kept for the other(s). As a result, different wavelengths escape at different positions along the waveguide.

According to this embodiment, multiple photo-voltaic cells which are optimized for different spectral ranges are arranged in a spaced-apart fashion at the corresponding different locations along the waveguides at which they are exposed to light components of corresponding wavelengths. This technique provides that the differently spectrally optimized PV cells may be arranged along the same waveguide. Differently from spectral splitting configuration described with respect to FIG. 2 (in which the photo-voltaic cells are coupled to the distal ends of different waveguides), here the PV cells can be accommodated along a single waveguide. In the present example, the grating like structure formed along the waveguide may be a periodic structure, as well as a structure having a quasi random profile designed for breaking the total internal reflection condition at different locations for different spectral bands.

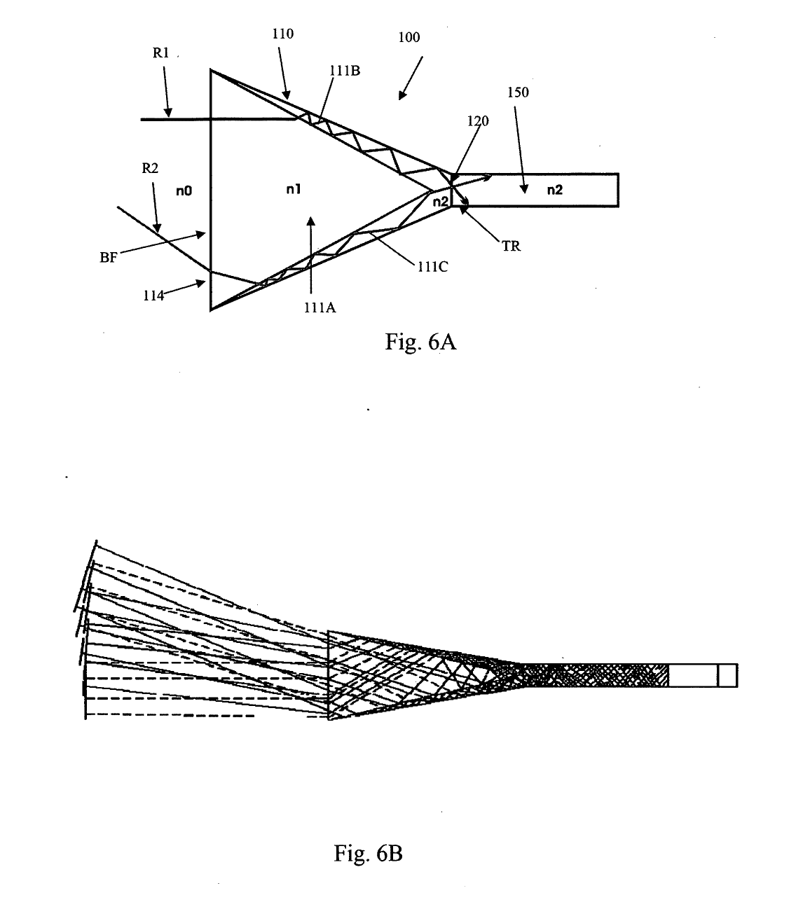

Reference is made to FIGS. 6A and 6B illustrating yet another embodiment of the present invention. FIG. 6A shows a light collection and concentration system 100 utilizing an anamorphic optical element 110 in the form of a prismatic structure. The prismatic structure 110 is formed by a prism 111A having a base facet BF serving as a light collection surface 114 and a top region TR serving as a projection region 120. The prismatic structure 110 also includes waveguides 111B, 111C extending along the side surfaces of the prism 111A. The prismatic structure 110 is configured for collecting and concentrating light by its light collection surface 114 and for concentrating the collected light by guiding it via the effect of total internal reflection inside the waveguides 111B and 111C.

As shown in FIG. 6A, a light beam (R1 and R2) enters the prismatic structure 110 through the effective aperture (light collection surface 114) and is appropriately refracted at this surface in accordance with a predetermined difference between refraction indices n₀ of the surroundings (e.g. air) and n₁ of the properly selected material of the prism 111A. This refraction leads to a reduction in the propagated angular range. Thus, light rays R1 and R2 impinging on the surface 114 with different angles of incidence enter the prism 111A and propagate to refraction interfaces defined by the walls of the waveguides 111B and 111C having a different refraction index n₂. At these refraction interfaces the light rays R1 and R2 enter the respective waveguides 111B and 111C and remain confined to propagate therein. The waveguides 111B and 111C guide the light rays to the projection region 120 where they are optically coupled into an output waveguide 150. Waveguide 150 transmits the so collected and concentrated light radiation to a remote receiving location, e.g. a photo-voltaic cell. The light collection system 100, similar to the above described examples, can collect radiation emerging from different directions into the same or different waveguides.

FIG. 6B shows simulation of light collection and concentration by the prismatic structure shown in FIG. 6A. The simulation of light propagation to and through the prismatic structure 110 is performed for input angular range of 0 to 20 degrees. Since the design of the prismatic structure is symmetric, the same result is expected also for angular range of (−20 to 0) degrees. The obtained concentration factor in this simulation is 4. The applied refractive indices for this simulation were n₀=1 (air), n₁=1.437 (Schott FK54 glass) and n₂=1.952 (Schott SF59 glass). This simulation is one-dimensional simulation performed along the axis of “summer-winter” movement. The concentration factor is associated with the higher refractive index (Snell law) as seen from Eq. (1). Thus, taking into account both the movements, along the day-night and summer-winter axes, the overall concentration can be of a factor of 8 (=4×1.952).

It should be noted that according to the invention prismatic structure illustrated in FIG. 6A is preferably an anamorphic structure. Accordingly, with respect to the second direction of the Sun's movement (e.g. along the axis of “day-night” movement) an efficient light collection within a full range of 180 degrees may be achieved in similar fashion as described above with reference to FIGS. 1 and 2.

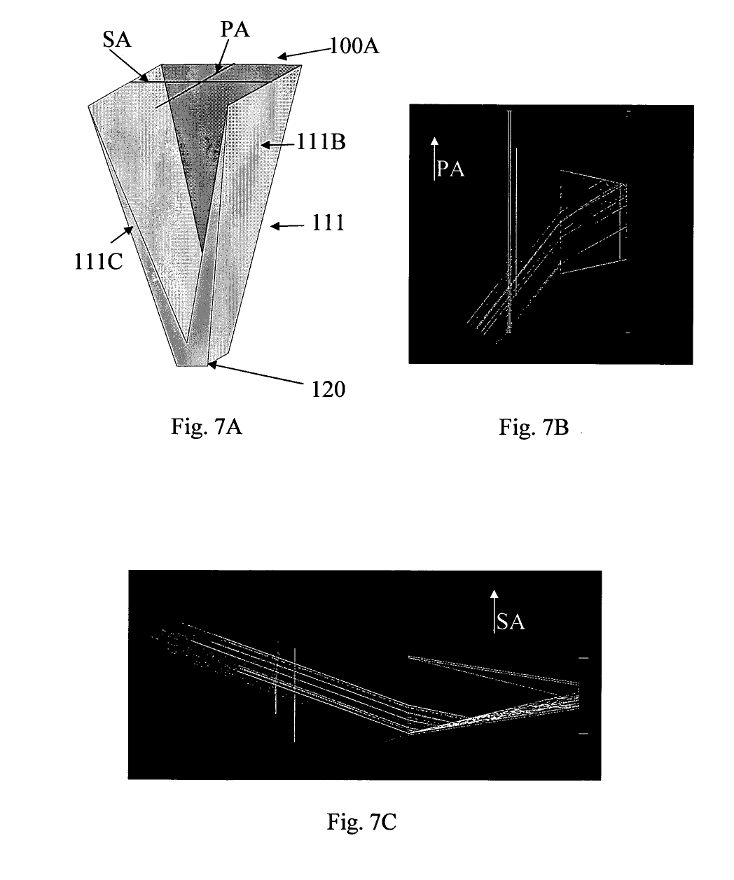

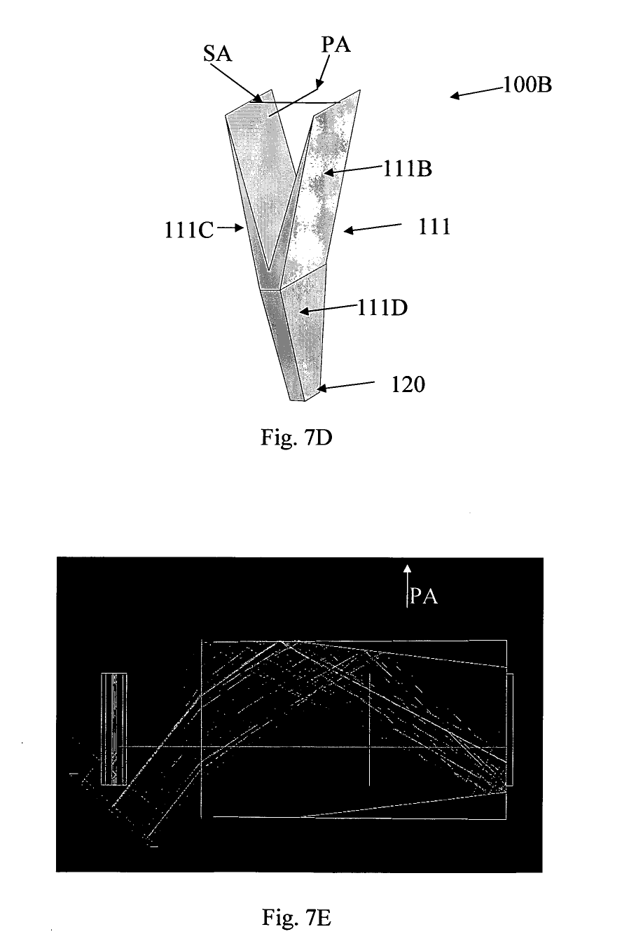

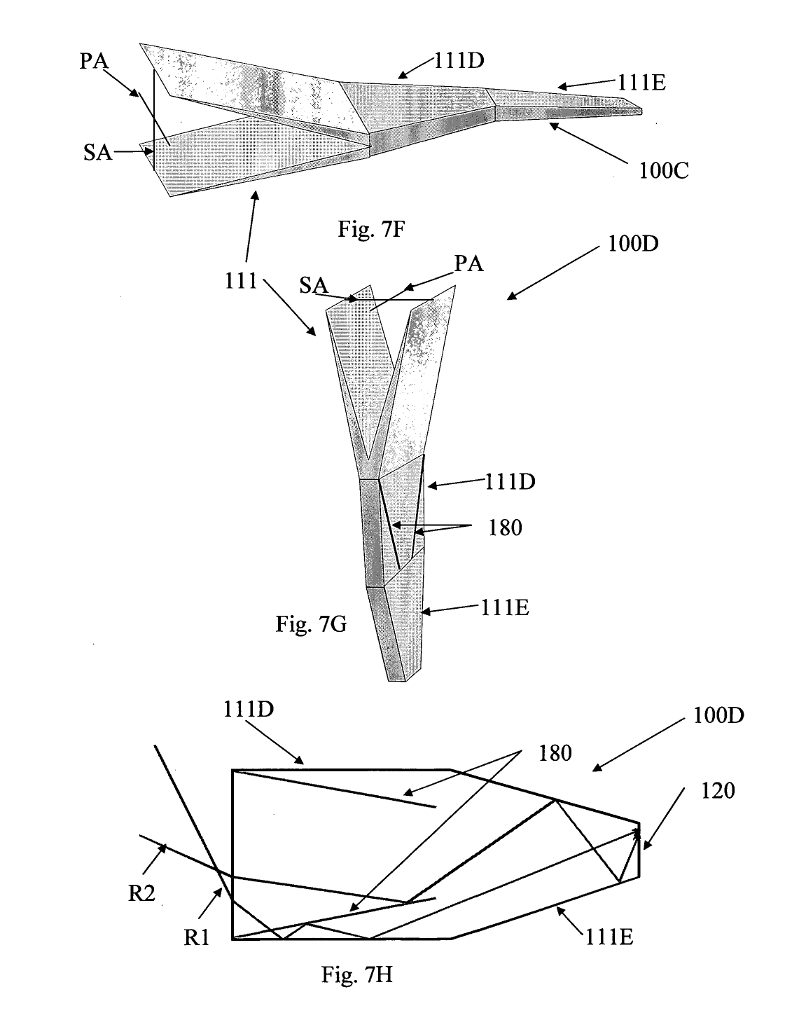

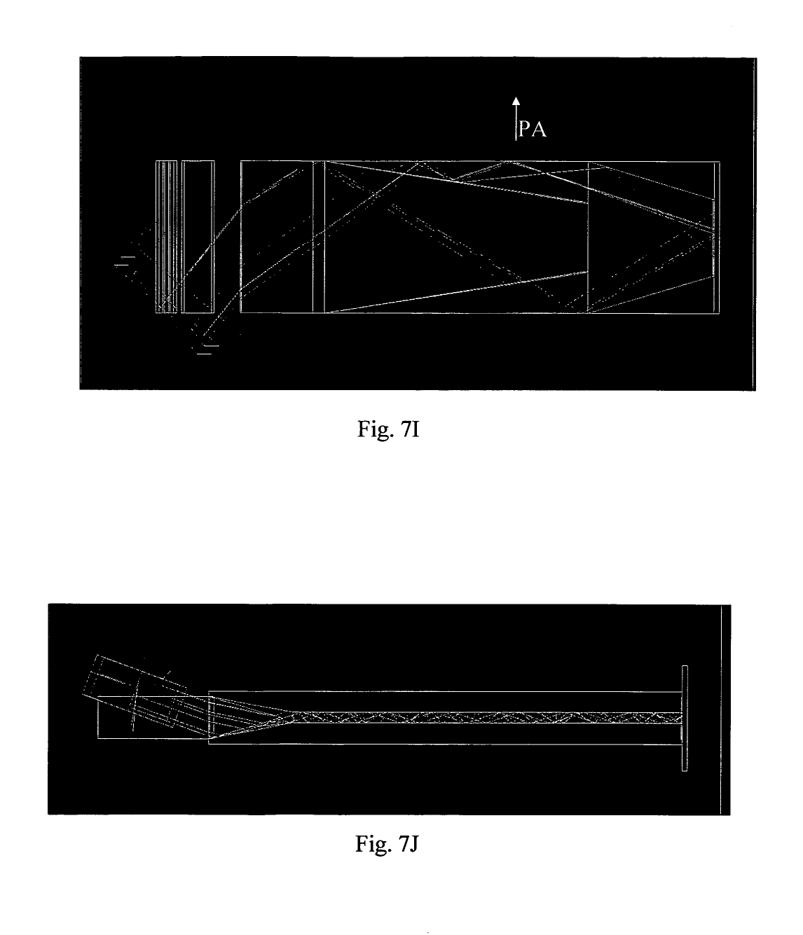

Different configurations of the prismatic structure according to an embodiment of the present invention are shown is FIGS. 7A-7J together with simulation result. FIGS. 7A-7J refer to different configurations of light collector and concentrator providing a two-dimensional concentration of light, i.e. concentrating the collected light on both the primary and secondary axes of the optical element. FIG. 7A illustrates a simple one-stage two-dimensional light concentrator 100A configured to collect and concentrate light arriving with angle of up to 50 degrees to each side along the primary axis PA of the collector and up to 20 degrees to each side along the secondary axis SA.

The light collector 100A is configured generally similarly to that of FIG. 6A. Specifically, the side walls parallel to the primary axis PA of the collector are configured as waveguides (111B, 111C) for the collected light. The side walls parallel to the secondary axis SA are configured as mirrors and are configured allowing a narrowing configuration of the light collector along its optical axis for providing higher light concentration ratio.

FIGS. 7B-7C show simulation results of light rays collected by the collector of FIG. 7A. FIG. 7B shows a cross-sectional view of the light collector 100A of FIG. 7A taken perpendicularly to its secondary axis SA. Simulated light rays are illustrated arriving with angle of about 50 degrees with respect to the optical axis. FIG. 7C shows a cross-sectional view of the light collector 100A taken perpendicularly to its primary axis PA. The collection of light rays arriving with angle of 20 degrees from the optical axis is simulated.

FIG. 7D illustrates an example of a two-stage configuration of the light collector and concentrator 100B. This two-stage configuration is constructed from a first prismatic structure 111 (similar to that shown in FIG. 6A) coupled to a narrowing waveguide 111D. The prismatic structure 111 provides concentration of light with respect to the secondary axis while the narrowing waveguide 111D, which may be a planar trapezoid/triangular shaped waveguide, provides for concentration of light with respect to the primary axis PA of the light collector. FIG. 7E shows simulation results of light rays propagating through the two-stage light collector and concentrator 100B of FIG. 7D. The figure shows a cross-sectional view of the light propagation taken perpendicularly to the secondary axis of the light collector 100B.

Three-stage light concentration configurations are exemplified in FIGS. 7F and 7G. In FIG. 7F three-stage light concentration system 100C is shown including a two stage structure (similar to that shown in FIG. 7D having a first prismatic structure 111 coupled to a narrowing waveguide 111D) and a second narrowing waveguide 111E is optically coupled to the narrowing waveguide 111D and configured to further concentrate light along the secondary axis SA of the light collector.

FIG. 7G shows another example of a three-stage light concentration system 100D similar to the light concentration system 100C above. Also here the prismatic structure 111 is connected to a planar waveguide 111D and a second narrowing waveguide 111E is aligned after the first waveguide 111D. However, here the waveguide 111D is configured with two planar interfaces with lower refractive index (the line 180 illustrated within the waveguide 111D designates the interface between the two different refraction indexes). These interfaces 180 can be formed for example by cracks filled with material refractive index lower than the refractive index of the core of waveguide 111D and/or by combining two types of materials to construct waveguide 111D such that line 180 designates the interface between them. As illustrated below, these interfaces 180 are configured according to the invention for reducing the angular distribution of light propagating through the waveguide and thus allow improved light concentration.

FIG. 7H illustrates light propagation through the waveguide 111D and a second narrowing waveguide 111E (performing the second and third light concentration stages) of the light concentration system 100D of FIG. 7G. Light rays arriving with large angle R1 (larger than a certain threshold angle) pass through the interfaces 180 and are reflected from the walls of the waveguide 111D. Light rays arriving with lower angles R2 (lower than the threshold) are reflected from the interface 180. As a result, the light beams are propagating downstream towards the narrowing waveguide 111E with reduced angular distribution where they are further concentrated by the narrowing waveguide 111E. Simulation results for the light collection/concentration system 100D of FIG. 7G are illustrated in FIGS. 7I-7J showing concentration of light arriving from different directions into the light collection system 100D.

It should be noted that light conversion system for converting the light to electric power can be located adjacent to the light collection/concentration system of the invention or in remote location. For example, light may be collected from the projection region 120 of the above described prismatic configurations by one or more waveguides and transported thereby to photo-voltaic cell(s) located at some distance from the collection system. Light may also be directly coupled into photo-voltaic cell(s) located near/at the projection region 120.

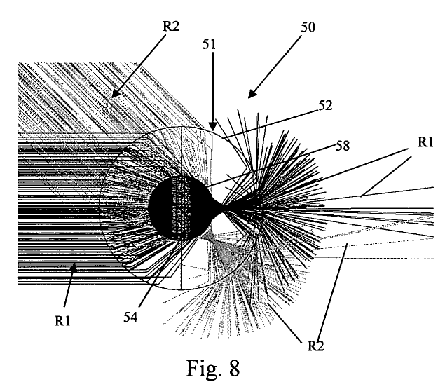

Reference is now made to FIG. 8 illustrating yet another embodiment of the present invention. A light collection and concentration system 50 is shown configured for use for example with one or more cylindrical photo-voltaic cells. The light collection and concentration system 50 advantageously provides significant sealing of the photo-voltaic cell and can also be integrated therewith. The system 50 includes a cylindrical optics 51 which may have a circular (or partially circular) cross-sectional shaped of the light collection surface 52. The cylindrical optics 51 is configured as a sealing tube for a receiving element 58 (photo-voltaic cell) accommodated therewithin and/or attached thereto. Light collected by the light collection surface 52 is concentrated/focused due to its circular cross-section onto a projection/focal spot located within the cylinder at a projection region 54. The receiving element 58 is located substantially at the central region of the cylindrical optical element 51 such that collected light arriving from a predetermined angular range (e.g. from all directions in case of full circular cross-section) is sufficiently concentrated at the projection region 54. The receiving element 58 is preferably a cylindrical photovoltaic cell and/or it may include a waveguide or an input facet thereof.

When utilizing cylindrical optics 51 having a fully circular cross-section, the concentration system 50 is insensitive to the position of the Sun (light source), and the concentration factor corresponds only to the square of the refraction index of the material from which the optics cylindrical 51 is made (as is evident from eq. 1). The system 50 can thus be used with a cylindrically structured PV cell which has significant sealing advantages. The system 50 can collect radiation emerging from any possible position of the Sun. A simulations of light rays R1 and R2 originated at different locations (different successive positions of the Sun) and collected by the optics 51 is shown is the figure.

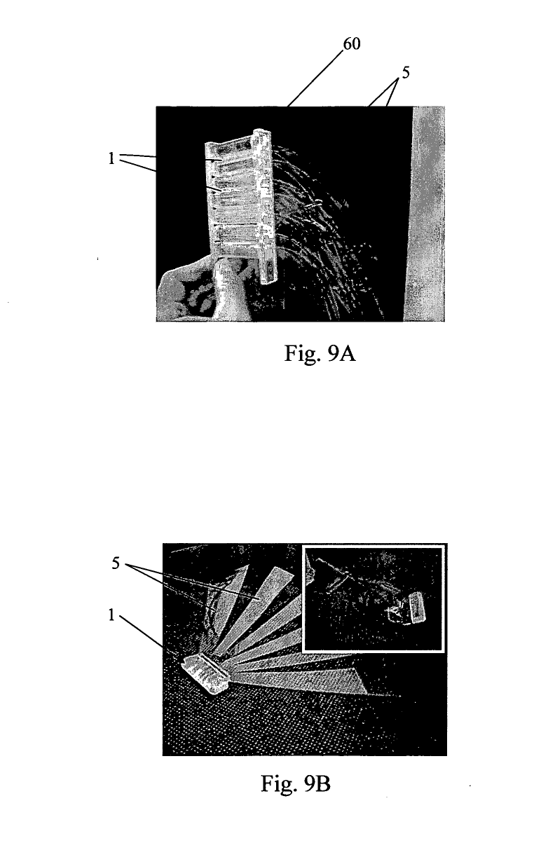

Reference is now made to FIGS. 9A and 9B showing the experimental results obtained with the present invention. FIG. 9A shows a constructed laboratory demonstrator 60 formed by a set of light collector and concentrators, generally at 1, constructed and operated as described above with reference to FIGS. 3A and 3B, and associated with a set of receiving waveguides 5 (the input facets of which are located at the receiver aperture constituted by the projection region of the cylindrical lens). FIG. 9B shows a single cylindrical lens collector 1 coupling the collected light into a set of flexible planar waveguides 5. The inset of FIG. 9B shows how the flexibility of the waveguides allows for directing light, collected from different directions, into the same PV cell. The flexibility of the waveguides allows, for instance, for matching the optics to different dimensions of the PV cells. In case where the dimensions of the photo-voltaic cells are different than those of the collection optics, the waveguides can be split into a set of thinner waveguides that later on can be folded to match the photo-voltaic cell architecture (the folding appears in the upper right part of the figure).

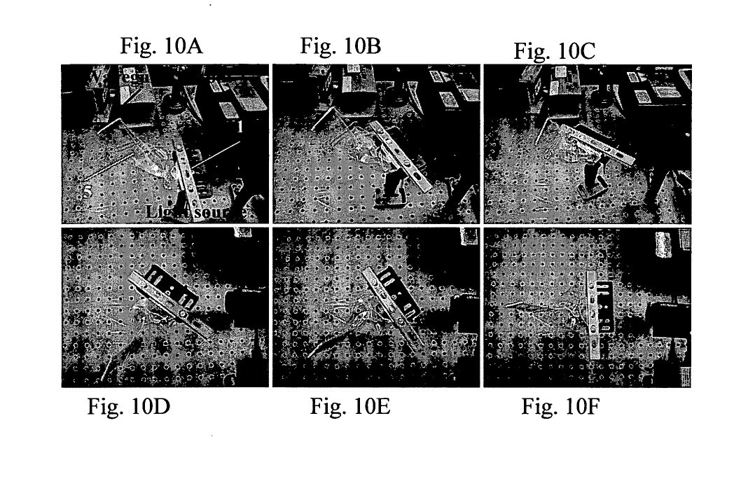

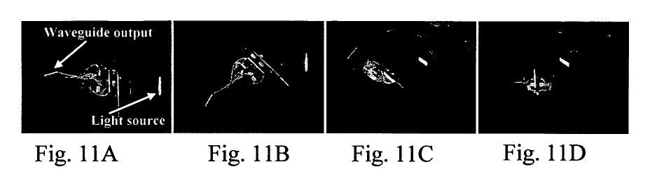

FIGS. 10A to 10F show the experimental results of illumination of the device of the present invention (i.e. cylindrical lens) with a green laser, whose position is varying along a one-dimensional trajectory (along an axis) substantially parallel to the optical axis of the cylindrical lens. This movement of the light source corresponds to the movement of the Sun during the day. As shown in the figure in a self-explanatory manner, light, coming from different directions (different successive positions of the light source relative to the lens), is coupled into the waveguide and is always brought to a desired position in space. The light comes from right to left and the flexible waveguide is bended to bring the coupled radiation upwards, i.e. to a specific point instead, of being spread along the whole one-dimensional exit facet of the waveguide. The results of a similar experiment performed with the use of white light illumination are shown in FIGS. 11A to 11D. The experimental results shown in FIGS. 10 and 11 illustrate the radiation collection corresponding to the one-dimensional movement of the Sun.

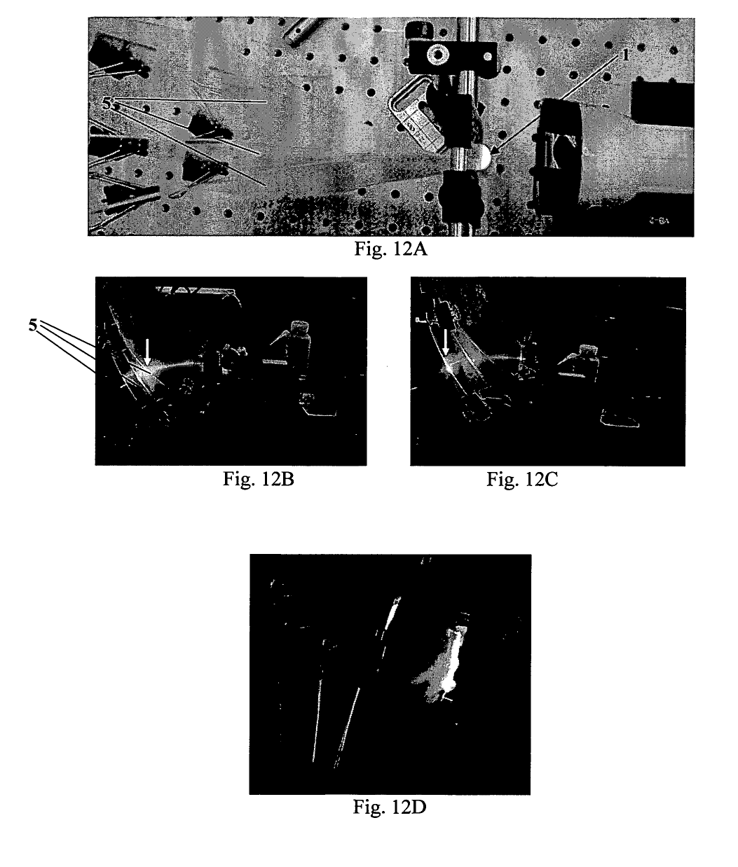

FIGS. 12A to 12E show experimental results corresponding to the movement of a light source along the second dimension of Sun's trajectory corresponding to the change in the orientation of the Sun about the primary axis of the anamorphic optical element (i.e. corresponding to the seasonal changes). FIG. 12A shows the results obtained with an experimental set up of the passive system for radiation collection from a movable light source moving along the second dimension which corresponds to the seasonal changes of the Sun's movement. FIGS. 12B and 12C demonstrate collection of light by the system from three different directions of illumination. In FIG. 12B the source is located at (−3) degrees angular position (tilt) with respect to the optical axis of the lens, and in FIG. 12C the illumination is coming from a direction corresponding to (+3) degrees tilt. The light output from associated waveguides is marked by arrows in these figures showing how the light is shifted from one waveguide to another waveguide due to the change in the tilting. As shown, the system is insensitive to the direction (in axis of the focal power of the lens) of the illuminating source (for green light in the present example). Light collected from different directions along the summer-winter axis is coupled into different waveguides, which are bended in order to guide the light into the same photo-voltaic cell. FIG. 12D shows in a self-explanatory manner a similar experiment performed with a white light source.

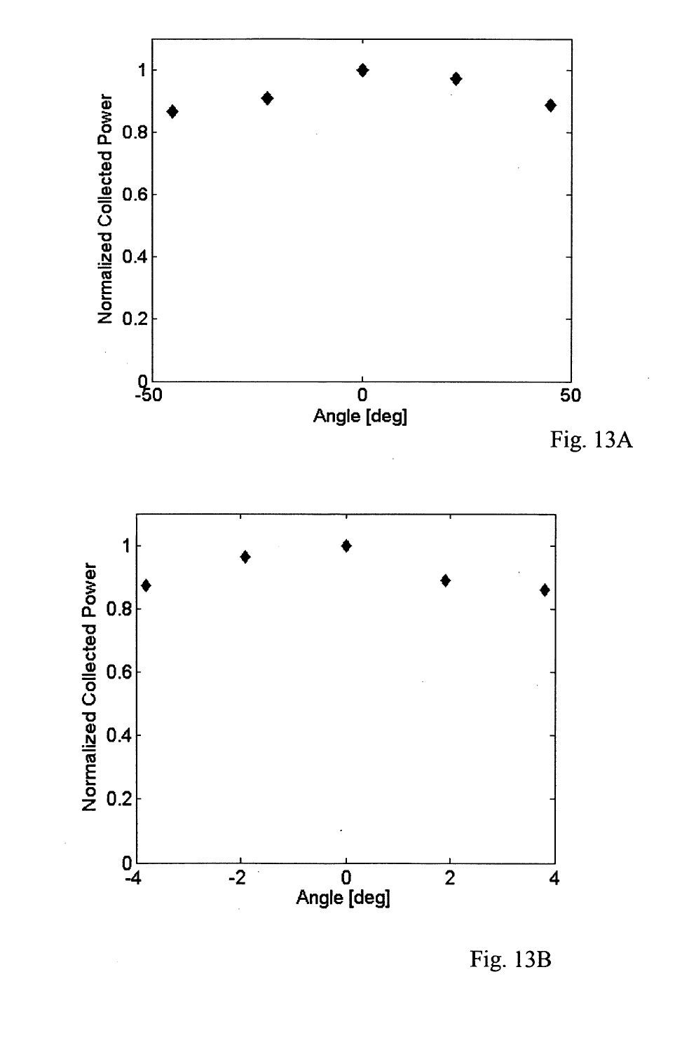

Referring now to FIGS. 13A and 13B, there is exemplified the light collection efficiency of the system of the present invention. These figures show the normalized collected power for different collection angles. FIG. 13A shows illumination directions along the optical axis of the lens, corresponding to the “day-night” trajectory, and FIG. 13B shows illumination directions in a plane perpendicular to that axis, corresponding to the “summer-winter” trajectory. It is thus evident that the collection power is desirably high for all the positions of the light source during its movement along the respective trajectories

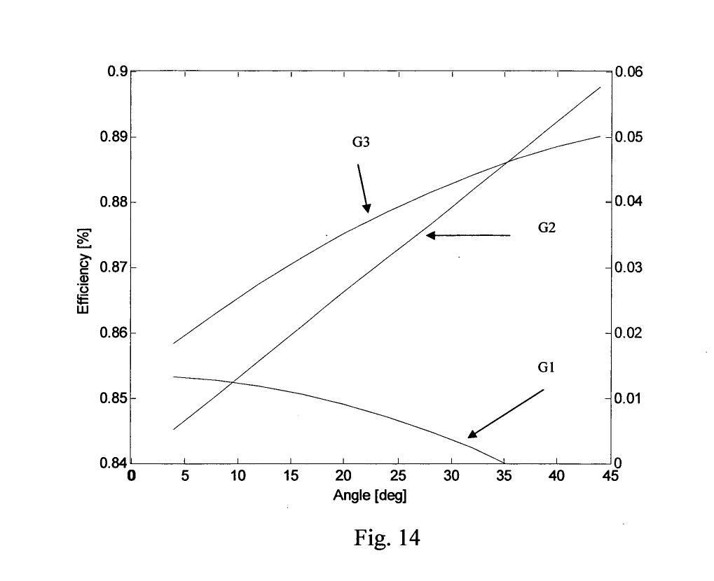

FIG. 14 demonstrates two effects that are relevant to the efficiency of energy collection by the system of the present invention. Graph G1 shows the reduction in the radiation collection (reduction of energetic collection efficiency) which is due to the cross sectional area of a passive collection system appearing smaller as the light source is tilted with respect to the optical axis. Graph G2 illustrates the increase in the efficiency which is due to the fact that the passive light collection system of the invention is capable of efficient collection of light from various directions with respect to its optical axis and thus also efficiently collects diffused light and not only direct light from the source. Also shown in the figure is graph G3 corresponding to the overall trend in the collection efficiency. Graph G3 shows the combined effect of the cross-sectional reduction and the collection of diffused light while considering a typical day light environment in which the diffused light is about 30% from the entire light radiation energy. As shown from this graph the passive light collection system of the invention provides increased light collection efficiency.

Mathematically, denoting the angle along the “summer-winter” axis/trajectory by θ_{S-W}, and the angle in the “day-night” axis/trajectory by θ_{D-N}, the area reduction A_{η} (for “day-night” range of 110 degrees) is given by:

$${A}_{η} = \frac{4 {\int }_{0}^{{θ}_{S - W}} {\int }_{0}^{{θ}_{D - N}} cos {θ}_{1} cos {θ}_{2} d {θ}_{1} d {θ}_{2}}{4 {θ}_{S - W} {θ}_{D - N}} = \frac{sin ( {θ}_{S - W} ) sin ( {θ}_{D - N} )}{{θ}_{S - W} {θ}_{D - N}} \qquad ( 3 )$$

and the energy that is being added due to the diffused light equals to:

$${E}_{d} = \frac{0.3 \times {θ}_{S - W} {θ}_{D - N}}{2 π} \qquad ( 4 )$$

The combination of these effects provides for an increase in the efficiency of light collection achievable with the system of the present invention.

Thus, the invention provides a simple and effective solution for passive light collection and concentration system. As indicated above, the system defined a receiver aperture where concentrated light can be coupled directly to one or more receiving locations/receiver elements, or via one or more waveguides. In the latter case, the waveguide may be planar and/or flexible thus facilitating connection between remotely located receiver aperture (collector and concentrator) and receiving location/element, also the waveguide may be desirably inexpensive, e.g. plastic waveguide.

Those skilled in the art will readily appreciate that various modifications and changes can be applied to the embodiments of the invention as hereinbefore described without departing from its scope defined in and by the appended claims.

1. A system for collecting and concentrating light from a moving light source, the system comprising:
at least one anamorphic optical element, defining an optical axis and a projection region and having a predetermined effective aperture which defines primary and secondary axes; said effective aperture is configured for collection of optical radiation arriving from a predetermined solid collection angle defining a first range of angles with respect to a plane spanned by said optical and primary axes; said anamorphic optical element is configured such that light passing through said effective aperture within a predetermined first range of angles within said predetermined solid collection angle is concentrated onto at least a part of said projection region; and
at least one receiver aperture defined by at least a part of said projection region.

2. The system of claim 1, wherein said projection region is an elongated region substantially parallel to said primary axis, and said anamorphic optical element is configured for collecting and projecting, onto substantially overlapping parts of said elongated region, optical radiation arriving from different angles within a second predetermined range of angles with respect to a plane spanned by the secondary and optical axes.

3. The system of claim 1, wherein said first range of angles is selected in accordance with a known trajectory of radiation source movement during a certain period of time.

4. The system of claim 2, wherein said second range of angle is selected in accordance with a known trajectory of radiation source movement during a certain period of time.

5. The system of claim 1, wherein said anamorphic optical element comprises a cylindrical lens curved at least about said primary axis.

6. The system of claim 5, wherein the effective aperture of the cylindrical lens has an elongated shape aligned along said primary axis.

7. The system of claim 1, wherein said anamorphic optical element comprises a prismatic structure having a facet defining said effective aperture, and defining a top region comprising said projection region; wherein the side walls of said prismatic structure are constructed as waveguides for guiding collected light by total internal reflection from said effective aperture towards the top region of the prismatic structure.

8. The system of claim 1, wherein said at least one receiver aperture is associated with one or more receiving elements.

9. The system of claim 8, wherein said one or more receiving elements comprises one or more photo-voltaic cells.

10. The system of claim 9, wherein the anamorphic optical element is formed as a sealing element of said one or more photo-voltaic cells.

11. The system of claim 10, wherein said anamorphic optical element has a focal region located downstream from said receiving element with respect to the direction of light propagation through the anamorphic optical element.

12. The system of claim 1, comprising a spectral splitting assembly.

13. The system of claim 12, wherein said spectral splitting assembly comprises a diffraction structure located at said effective aperture of the anamorphic optical element.

14. The system of claim 8, wherein at least one of said one or more receiving elements comprise one or more waveguides configured for coupling thereto at least a part of the collected radiation.

15. The system of claim 1, wherein said receiver aperture is a common input aperture of at least two waveguides; each of said least two waveguides is configured for coupling thereto at least a portion of the collected radiation incident onto said effective aperture such that different angular segments of said first range of angles, are coupled to different waveguides.

16. The system of claim 14, wherein said projection region is an elongated region; said one or more waveguides are configured as planar waveguides optically coupled to the elongated region.

17. The system of claim 14, wherein said one or more waveguides are flexible.

18. The system of claim 14, wherein at least some of said waveguides guide the radiation coupled thereto towards different locations.

19. The system of claim 14, wherein at least some of said waveguides guide the radiation coupled thereto towards the same location.

20. The system of claim 14, wherein said waveguide is an optical fiber element of an optical communication network.

21. The system of claim 14, comprising a spectral splitter extending along a surface of the waveguide for separating light portions of different spectral ranges and allowing their output from the waveguide at spaced-apart locations respectively along the waveguide.

22. The system of claim 1, wherein said first range of angles is at least 12°.

23. The system of claim 1, wherein said first range of angles is at least 44°.

24. The system of claim 2, wherein said second range of angles is about 110°.

25. A solar radiation system comprising said optical light collection and concentration system of claim 1, and at least one photo-voltaic cell having a light receiving surface extending along at least a part of said receiver aperture.

26. A solar radiation system comprising said optical light collection and concentration system of claim 1, and one or more waveguides having one or more input facets respectively extending along one or more parts of said receiver aperture.

27. An optical light collection and concentration system, wherein the system comprises a cylindrical receiving element and a cylindrically shaped optical element configured as a sealing for said receiving element; the receiving element is placed substantially at the central region of said cylindrically shaped optical element and is arranged to receive light collected and concentrated by said cylindrically shaped optical element.

28. The system of claim 27 wherein said receiving element is a cylindrical photo-voltaic cell.

29. A method for collecting solar radiation onto one or more photo-voltaic cells, the method comprising:
(a) providing a solid angle of solar radiation propagation in accordance with a first direction corresponding to the trajectory of the Sun during the day and a second direction in which said trajectory varies between seasons and determining, based on said first and second directions, first and second angular ranges corresponding to the direction of the Sun light propagation during the day and in different seasons;
(b) configuring an anamorphic optical element having an effective light collection aperture a first and second different optical functions associated with primary and secondary axes of the anamorphic optical such that said first optical function being operable to collect and concentrate light arriving from different directions within said first angular range and to direct the concentrated light on to substantially the same light projection region, and said second optical function being operable for collecting and concentrating light arriving from different direction with respect to said second angular range ant to project the concentrated light onto substantially overlapping regions at said projection region; and
(c) coupling one or more receiving apertures to said projection region for collecting there from concentrated light arriving from any direction within said solid angle.

30. The method of claim 29 wherein said anamorphic optical element is configured as a prismatic structure having a facet defining a light collection surface of said effective light collection aperture, and a top region comprising said projection region; and wherein at least two side walls of said prismatic structure are constructed as waveguides configured and operable for collecting light incident on said effective light collection aperture such that light is concentrated in said waveguides and is guided by said waveguides towards the projection region.

31. The method of claim 29 wherein said anamorphic optical element comprises a cylindrical lens.

32. The method of claim 31 comprising, providing said cylindrical lens to form sealing element for a cylindrical photo-voltaic cell, wherein said one or more receiving apertures being a receiving aperture of said cylindrical photo-voltaic cell.

33. The method of claim 29, further comprising providing a spectral splitting assembly on top of said effective aperture for spectral splitting of collected solar radiation.

34. The method of claim 29 further comprising arranging said one or more receiving apertures as input facets of one or more waveguides configured to transport collected light to one or more distant receivers.

35. The method of claim 29 further comprising arranging said one or more receiving apertures as receiving apertures of one or more photo-voltaic cells.

36. A method for collecting solar radiation onto one or more photo-voltaic cells, the method comprising:
(a) providing a solid angle of solar radiation propagation in accordance with a first direction corresponding to the trajectory of the Sun during the day and a second direction in which said trajectory varies between seasons and;
(b) providing a system for collecting and concentrating light from a moving light source as defined according to claim 1; and
(c) mounting and said system such that its primary and secondary axes are substantially parallel to said first and second directions respectively to thereby optimize a solid angle from which Sun light is collected by said system.

37. The method of claim 36 wherein said system is stationary mounted such that its optical axis is directed substantially towards the nominal position of the Sun to optimize harvesting of Sun light energy.

38. The method of claim 36 wherein said system is associated with solid angle of light collection smaller than the solid angle of the solar radiation propagation; and wherein said system is shiftably mounted for rotation of its optical axis such as to allow light collection from said solid angle of solar radiation propagation.
